(19) United States
(12) Patent Application Publication
(10) Pub. No.: US 2015/0179008 A1
(43) Pub. Date: Jun. 25, 2015

(54) LOCK/UNLOCK METHOD IN CONJUNCTION WITH NEAR FIELD WIRELESS TRANSMISSION DEVICE

(71) Applicant: JetDian Technology, Inc., Taipei City (TW)

(72) Inventors: JUI-HUEI SUNG, TAIPEI CITY (TW); CHIN-YUAN CHENG, TAIPEI CITY (TW); KUAN-CHUN WANG, TAIPEI CITY (TW)

(21) Appl. No.: 14/578,440

(22) Filed: Dec. 21, 2014

(30) Foreign Application Priority Data
Dec. 20, 2013 (TW) 102147579

(51) Int. Cl. G07C 9/00; H04B 5/00

(52) U.S. Cl. CPC G07C 9/00111; H04B 5/0056

(57) ABSTRACT

A lock/unlock method in conjunction with a near field wireless transmission device which is applicable to a lock toolset, wherein the near field wireless transmission device includes a transmitter and a processor driving the transmitter to continuously transmit a predetermined wireless activation signal, and the lock toolset includes a controller, a memory recording an authentication code, a receiver for receiving said wireless activation signal, and an anti-theft lock driven to be opened by the instruction of the controller. The lock/unlock method includes the steps of: a) receiving the predetermined wireless activation signal by means of the receiver and converting it into an electric signal output; b) receiving the electric signal output by means of the controller and verifying it with the authentication code recorded in the memory; and c) instructing to drive the anti-theft lock to open in case the controller confirms a predetermined condition is satisfied.

### FIELD OF THE INVENTION

The present invention relates to a lock/unlock method in conjunction with near field wireless transmission device which is applicable to a lock toolset in conjunction with a near field wireless transmission device.

### BACKGROUND OF THE INVENTION

The lock is one of the items in close contact with people in daily lives. Conventional mechanical lock structures develop from typical single spring lock toward multi-faced and multi-rowed configurations. However, defects in such mechanical locks are still obvious, which are vulnerable to external force, and also keys thereof may be lost, missed or even maliciously duplicated, thus inevitably leading to deep concerns in applications. To resolve such issues existing in mechanical locks, inventors have made researches in order to improve lock securities, thus leading to the emergence of electric locks.

As the electric lock has a huge password capacity and is workable in combination with mechanical locks to enhance security, the advantageous feature thereof that there is no need to carry a key for electric lock. In modern society, people may have to carry a big bunch of keys along with them, which can be very cumbersome. Hence, through the conjunctive operation of electric lock and wireless induction device, people need to simply memorize a password string or apply fingerprint identification, rather than grasping massive but non-exchangeable keys to try to open a lock. This further eliminates the key mislaying and illicit duplication problems.

Although the electric lock may bring many benefits to people's daily lives, collateral flaws do occur. For example, the electric locks of this type need to be powered all the time. It means that they should be plugged into a mains socket or provided with an internal battery, so that they are enabled to continuously transmit signals and the sensor/receiver device on user's hand can receive the signal and send back a release signal to unlock. However, while the approach of electrical connection to a mains socket can be only applied to immobile devices, it is impractical for portable products, such as a bicycle, a luggage case and so on. Besides, in the case of installing internal batteries inside the electric lock, users may still need to pay heed to residual power amount of the battery during application. This is because once the battery power depletes, the electric locks of this type may not operate normally and the user can only wait for maintenance personnel to help out. The originally expected convenience of the electric lock may be largely reduced due to such concerns. As a result, for portable devices such as a bicycle or a luggage case, it is required to ensure that the security lock cannot be easily opened while the anti-theft mechanism cannot be ungraded arbitrarily due to the limited available space or other resources. When a bicycle rider gets off and departs, it is very typical to lock it up to protect against thieves. However, a combination lock may be unlocked through multiple tryouts, thus providing poorer anti-theft ability. A key lock may increase the risk of key loss or mislaying for the rider. Moreover, for thieves having professional purloin skills, the conventional key locks may not effectively impede their criminal actions unless using a sufficiently exquisite and sophisticated key lock.

To resolve the aforementioned power amount issue, some vendors have considered supplying electric power to the electric lock upon inserting the key into the keyhole, thereby attempting to temporarily eliminate this power insufficiency problem. Unfortunately, although this approach of supplying electric power to the electric lock upon inserting the key into the keyhole sounds handy, it can be risky as well. A thief can utilize the open source hardware, e.g., Arduino, to unlock. Arduino is a kind of open source single chip microcomputer, which can be programmed to perform complicated actions by means of simple programming language. Since there is at least one signal line for writing, memorizing and reading the stored code in an electric lock of this type, the thief can easily crack the security of the electric lock by connecting Arduino to the signal line of the electric lock through a conductive line, thereby reading the stored code from the electric lock and sending it back to unlock.

As for the locking and unlocking operation using middle-ranged electro-magnetic signals, seeing that the remote controller emits signals in every direction, malicious persons may hold a set of sensor/receiver devices to illegally receive the transmitted signal upon the user pressing down the remote controller to unlock and then follow or wait for a chance to steal. As this kind of malicious recording on remote controller signals happen frequently, the user may concern about this issue.

As such, the present invention provides a lock/unlock method in conjunction with near field wireless transmission device, which allows to omit the power connection hole on the electric lock by placing the power supply device into the near field wireless transmission device to prevent thieves from performing electric violent unlocking, and also protects user's passwords from being maliciously recorded by means of the operation distance limitation due to short-ranged wireless transmissions, thereby securing user's personal belongings from being stolen. Therefore, by virtue of the techniques disclosed herein, the invention provides improved protection for portable devices, such as a bicycle or a luggage case, under the circumstances that they are unable to connect to mains power.

### SUMMARY OF THE INVENTION

In one aspect provided herein is a lock/unlock method in conjunction with near field wireless transmission device, in which a user can unlock by means of a near field wireless transmission device, e.g., a mobile phone or a tablet computer enabling communication function, and through the feature that the mobile phone or tablet computer enabling communication function sends communication signals all the time in order to maintain connection to a base station, the user needs only to place the mobile phone or tablet computer enabling communication function in proximity to a bicycle or a luggage case thereby having it unlocked. Moreover, it is also possible to input a piece of code for deactivating an electric lock through handwriting on a touch panel of the mobile phone or tablet computer enabling communication function thereby allowing an additional protection for the portable device.

In another aspect provided herein is a lock/unlock method in conjunction with near field wireless transmission device, in which the near field wireless transmission device performs power recharging to the lock toolset so as to prevent electric violent unlocking of thieves thus enhancing the security of the portable device.

In yet another aspect provided herein is a lock/unlock method in conjunction with near field wireless transmission device, in which a modification code can be rewritten on a touch panel of the near field wireless transmission device to facilitate the user's convenience thereby increasing the application flexibility of the lock toolset.

In still another aspect provided herein is a lock/unlock method in conjunction with near field wireless transmission device, in which an electric lock can be locked/unlocked via proximal wireless transmissions thereby significantly reducing the risks of illicit password recording in order to protect user's personal belongings.

According to the aspects described above, the present invention provides a lock/unlock method in conjunction with a near field wireless transmission device, which is applicable to a lock toolset utilized conjunctively with the near field wireless transmission device, wherein the near field wireless transmission device includes at least a transmitter and a processor for driving the transmitter to continuously send out a predetermined wireless activation signal, and wherein the lock toolset comprises a controller, at least one memory responsible for recording an authentication code, at least one receiver for receiving said wireless activation signal when the transmitter approaches, and an anti-theft lock driven to be opened by the controller, the lock/unlock method comprising the steps of: a) receiving the predetermined wireless activation signal by means of the receiver and converting the predetermined wireless activation signal into an electric signal for output; b) receiving the electric signal by means of the controller and verifying the electric signal with the authentication code recorded in the memory; and c) instructing the anti-theft lock to unlock when the controller confirms that a predetermined condition is satisfied.

The present invention discloses a lock/unlock method in conjunction with near field wireless transmission device which allows to protect user's personal belongings by way of locking/unlocking the electric lock with close-ranged wireless transmissions, and also, using the distance limitation for power recharging the lock toolset by means of a near field wireless transmission device, prevents user's password from being maliciously recorded and blocks electric violent unlocking of thieves. In addition, when a user takes a mobile phone or a tablet computer enabling communication function, for example, as the near field wireless transmission device, the user may habitually retain the power for operations rather than depleting the power thereof. As a result, through the techniques of the present invention, users can follow their existing habits without deliberately considering whether the electric lock still has sufficient power amount for operations thereby facilitating user's convenience.

### BRIEF DESCRIPTION OF THE DRAWINGS

FIG. 1 shows a block diagram for a first preferred embodiment of the invention, illustrating that a mobile phone transmits a predetermined wireless activation signal to a lock toolset;

FIG. 2 shows a view for the first preferred embodiment of the invention, illustrating using a mobile phone to release a lock toolset installed on a bicycle;

FIG. 3 shows a view for the electro-magnetic valve illustrated in FIG. 2;

FIG. 4 shows a flowchart for the lock/unlock steps in the first preferred embodiment of the invention;

FIG. 5 shows a second preferred embodiment of the invention, illustrating that the lock toolset installed on a luggage case acquires electric power provided by a mobile phone through a USB connection line;

FIG. 6 shows a view for a conventional USB connection line;

FIG. 7 shows a block diagram for the second preferred embodiment of the invention, illustrating that a mobile phone transmits a release signal to a lock toolset;

FIG. 8 shows a flowchart for the code confirmation/modification steps in the second preferred embodiment of the invention;

FIG. 9 shows a third preferred embodiment of the present invention, briefly illustrating that the controller drives the power storage device to supply energy to open the anti-theft lock; and

FIG. 10 shows a block diagram for the third preferred embodiment of the present invention, clearly illustrating the connection relationships among each of the devices.

### DETAILED DESCRIPTION OF THE ILLUSTRATED EMBODIMENTS

The aforementioned and other technical contents, aspects and effects in relation with the present invention can be clearly appreciated through the detailed descriptions concerning the preferred embodiments of the present invention in conjunction with the appended drawings; moreover, in each embodiment, the same components will be denoted with similar numbers.

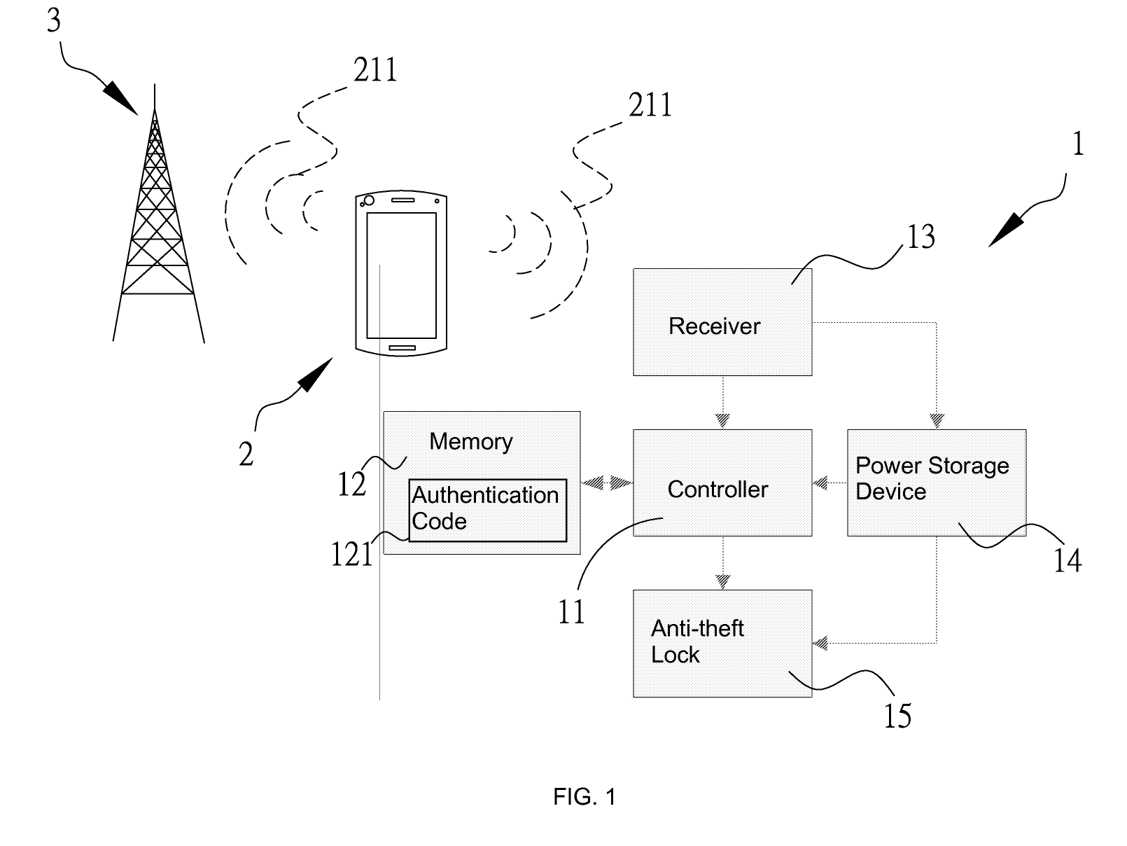

The electric lock disclosed herein can be applied on a portable device, which is exemplified herein as a bicycle. Referring to FIGS. 1 to 3, a bicycle 4 is provided with a lock toolset 1 comprising a controller 11, a memory 12, a receiver 13 and an anti-theft lock 15. As shown in FIG. 1, the near field wireless transmission device used in the unlock operation is exemplified herein as a mobile phone 2. Since the mobile phone 2 needs to communicate with a base station 3 all the time, the electro-magnetic waves transmitted for establishing such communication are referred to herein as a predetermined wireless activation signal 211. Since the electro-magnetic signals emitted based on such communication contain information like mobile phone serial number, SIM card serial number and so on, the receiver 13 according to the embodiment receives the wireless activation signal 211 and transmits the same to the controller 11 as the basis for determining whether the anti-theft lock 15 should be released or not. In addition, said anti-theft lock 15 is exemplified herein as an electro-magnetic valve.

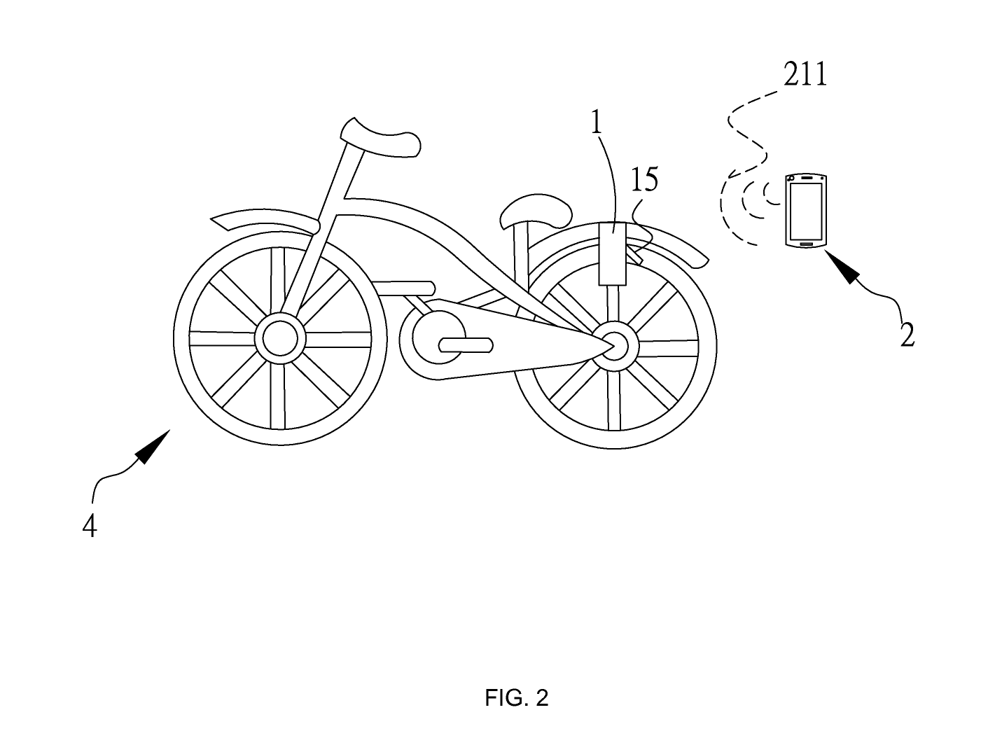

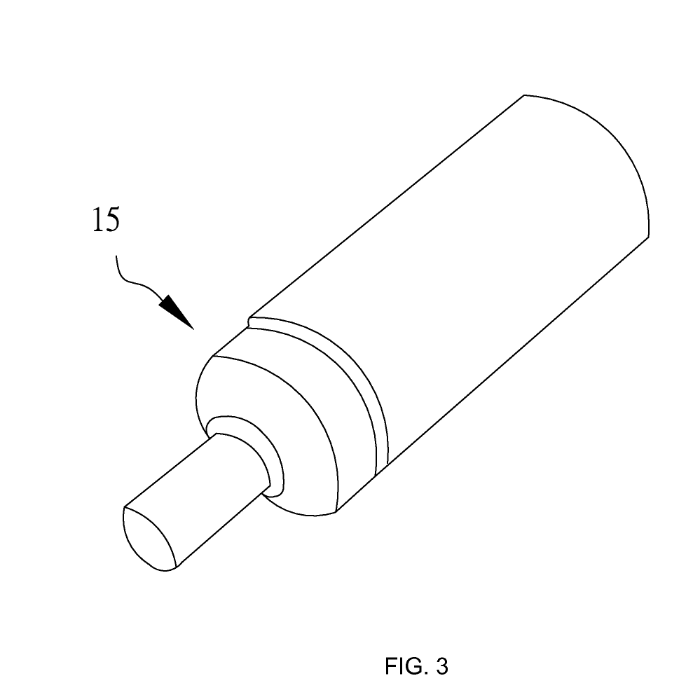

With regard to the first preferred embodiment of the invention, refer now conjunctively to FIGS. 2 and 3. The lock toolset 1 is installed on the bicycle 4 and cannot be connected to a mains socket. Thus, when a rider wants to unlock the bicycle 4, he/she may use the mobile phone 2 to control the processor (not shown) in the mobile phone 2 to drive a transmitter (not shown) to send out a predetermined wireless activation signal 211, so that the controller 11 in the lock toolset 1 is activated upon receiving electric power. When the power storage device 14 in the lock toolset 1 has filled with a given level of electric energy, the electric energy can be fed to the controller 11 and the anti-theft lock 15. Meanwhile, the receiver 13 in the lock toolset 1 converts the predetermined wireless activation signal 211 transmitted from the mobile phone 2 into an electric signal (not shown), so that the controller 11 can verify it with reference to the authentication code 121 recorded in the memory 12. After verification, the controller 11 instructs the electro-magnetic valve to release. The power storage device 14 is exemplified herein as a capacitor and the receiver 13 as an electro-magnetic coil.

By virtue of the structural arrangement described above, the rider can use a carried mobile phone to lock or unlock his/her bicycle. Moreover, although an electro-magnetic valve is exemplified in the present embodiment, those skilled in the art can readily appreciate that the similar function can be achieved by using motors, piezo-transistors (e.g., SiO₂, PZT and CdS) or the like.

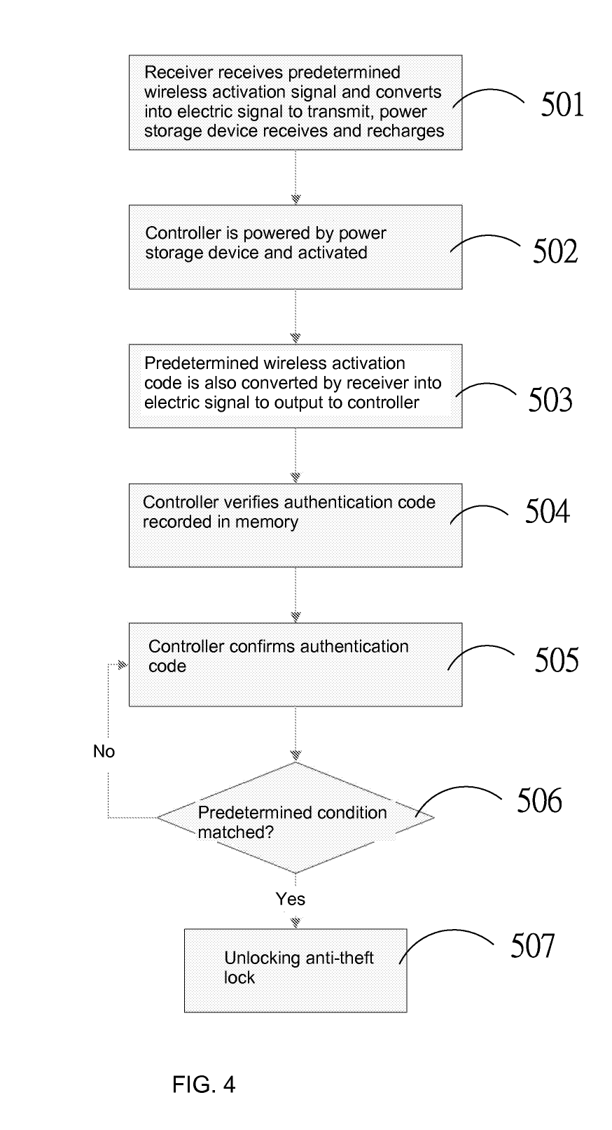

FIG. 4 shows a lock/unlock method disclosed herein. Initially, in Step 501, the receiver in the lock toolset receives the predetermined wireless activation signal and converts the same into a charge signal, thereby allowing the charging device to receive the charge signal to start a recharge operation. In Step 502, the controller is activated by the electric power supplied from the charging device. Then in Step 503, the wireless activation signal is also converted into an electric signal to be outputted to the controller. In Step 504, the controller verifies the electric signal with the authentication code recorded in the memory. Next, in Step 505, the controller confirms the authentication code. Following this, in Step 506, in the case where the aforementioned electric signal matches the authentication code, then in Step 507, the controller drives the anti-theft lock to open. On the contrary, if the controller finds out that the electric signal does not match, the present method returns to Step 505 and the controller verifies again the authentication code.

Through the descriptions provided above, several features of the present invention can be seen. Here, the method of using near field wireless transmission technology (e.g., RFID, NFC) for locking/unlocking a lock toolset can effectively block out illicit signal recording through interceptions performed by malicious people, whereby the user's personal goods can be protected. In addition, the near field wireless transmission device needs to continuously transmit signals, so as to keep in contact with the base station. Since the user of the near field wireless transmission device would habitually and spontaneously pay attention to the residual electric power in the near field wireless transmission device, it is not necessary to deliberately notice the electric power in the lock toolset. The electric power can be outputted to activate the controller in the lock toolset when the user is trying to release the lock, so that the controller can perform the verification and instruct the anti-theft lock to unlock. Therefore, while the lock toolset installed on the portable device is not connected to a mains socket, the portable device can still acquire sufficient drive power by way of the embodiment disclosed herein and can be protected by a better anti-theft means.

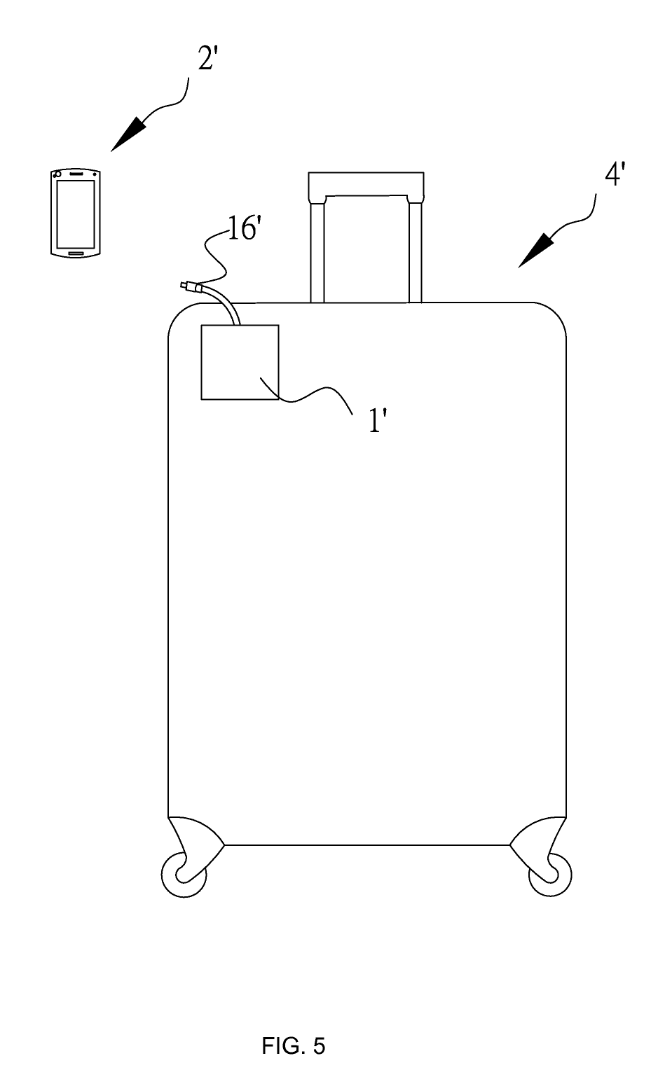

Now refer to FIGS. 5 to 8, where the second preferred embodiment of the present invention is shown. The portable device described the previous embodiment is herein exemplified as a luggage case 4′, and the lock toolset 1′ described in the previous embodiment further comprises a USB connection line 16′, so that the user may connect the USB connection line 16′ to a USB port (not shown) provided in the mobile phone 2′ described in the previous embodiment before unlocking, whereby the controller (not shown) in the lock toolset 1′ can receive the electric power required for activation.

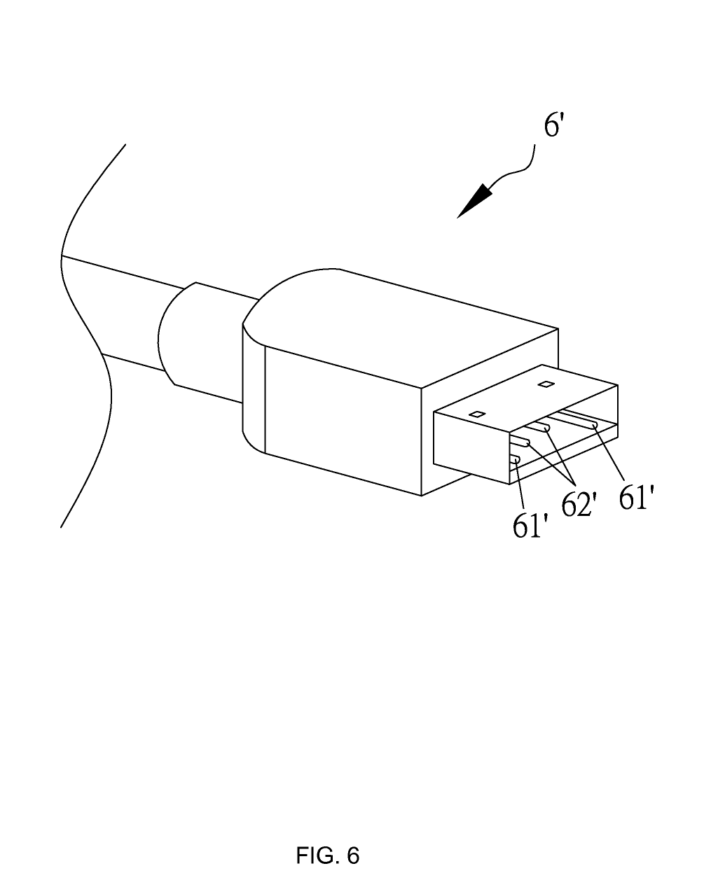

Referring further to FIG. 6, the conventional USB connection line 6′ has four pins, with two of them being power pins 61′, while the other two signal pins 62′. Since the USB connection line is mainly utilized for power transmission, the USB connection line 6′ needs only two power pins, and the other two signal pins may be not provided or otherwise may be provided but not linked to any circuits. Because these pins are not connected to any internal circuits of the lock toolset 1′, a thief cannot successfully complete signal connection and perform unlocking operation on the lock toolset by means of an open source hardware, such as Arduino described above. The security for the lock toolset 1′ disclosed herein is achieved accordingly.

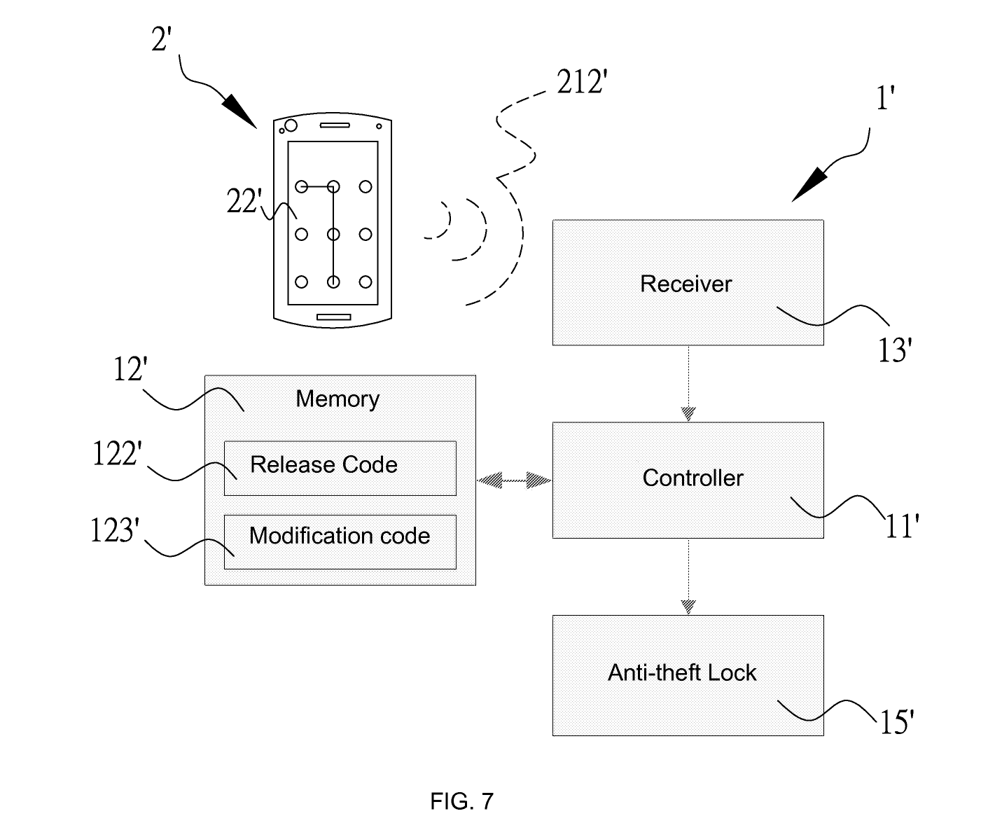

Next, referring to FIG. 7, since the USB connection line 6′ according to this embodiment is used only for power transmission to the lock toolset 1′, the user has to use the predetermined unlock program in an Application (APP) corresponding to the lock toolset 1′ to perform the unlock operation. When the controller 11′ in the lock toolset 1′ is activated by the power storage device (not shown) as described in the previous embodiment, the user may place the mobile phones 2′ close to the lock toolset 1′ installed on the luggage case 4′ and input a default graph on the touch panel 22′ as a release code 122′. Then the processor (not shown) in the mobile phone 2′ drives a transmitter (not shown) to convert it into a release signal 212′ and outputs to the lock toolset V. Afterwards, the lock toolset 1′ receives the release signal 212′ through a receiver 13′ as described in the previous embodiment and outputs it to the controller 11′, and the controller 11′ verifies it with the release code 122′ recorded in the memory 12′ to see if they match. Then, upon confirmed, the controller 11′ instructs the anti-theft lock 15′ to release as described in the previous embodiment. Additionally, those skilled in the art can devise that the aforementioned release code may consist of 26 English alphabets along with numbers to achieve the similar function.

In the case where the previously configured release code 122′ is to be modified, the user needs to use a default program for modifying the release code in the APP corresponding to the lock toolset 1′ to perform the modification. When the lock toolset 1′ was unlocked by the user's mobile phone 2′, the identity of the mobile phone 2′ was verified beforehand by the lock toolset 1′. Hence, the user can input a graph by himself/herself on the touch panel 22′ of the mobile phone 2′ to act as a modification code 123′. Then the processor (not shown) in the mobile phone 2′ drives the transmitter (not shown) to send out a modification signal (not shown) to the lock toolset 1′, such that the lock toolset 1′ receives the modification signal through the receiver 13′ and passes it to the controller 11′. Accordingly, the memory 12′ is instructed to record the modification code 123′ which is in turn used as a new release code 122′, and the previous release code 122′ is deleted or over-written. The memory 12′ will record the new release code 122′ for later application in releasing the anti-theft lock 15′.

Of course, the modification code allowable for spontaneous write-in and modification as described above may also exist along with the aforementioned release code formed by the internal data of the mobile phone, and any one of them can be selected to act as the unlock mechanism or, alternatively, it is required to provide both of them in accordance with user's demand.

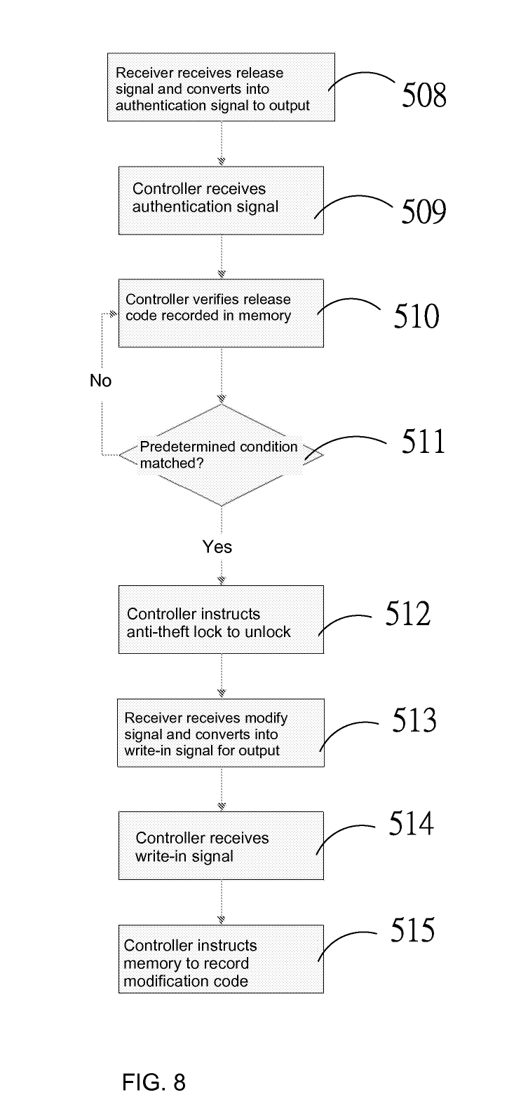

FIG. 8 shows the code confirmation/modification steps disclosed herein. In Step 508, the receiver of the lock toolset receives the release signal and the release signal is converted into an authentication signal for being output to the controller. Then in Step 509, the controller receives the authentication signal. In Step 510, the controller verifies the release code recorded in the memory. Next, in Step 511, the controller confirms whether the authentication signal matches the release code. In Step 512, if the authentication signal matches, the controller instructs the anti-theft lock to unlock. If the release code need be modified, then in Step 513, the receiver would receive the modification signal which is then converted into a write-in signal for being output to the controller. Subsequently in Step 514, the controller receives the write-in signal, and then in Step 515 the controller instructs the memory to record the modification code. Alternatively, if the controller verifies that the authentication signal does not match, the method returns to Step 511 where the controller verifies again the release code.

By virtue of the aforesaid code confirmation/modification steps, the user can use a carried mobile phone to input a release code on the touch panel of the mobile phone and the processor in the mobile phone can drive the transmitter to convert the release code into a release signal and output the same to the lock toolset, so that when the controller in the lock toolset installed on the luggage case confirms the correctness of the release code, the controller instructs the anti-theft lock to release. Therefore, in the case where the user owns an object of high security, the method disclosed herein is able to provide better protection for the luggage case. Certainly, those skilled in the art can readily appreciate that the code confirmation/modification steps described herein can be accomplished by, using a predetermined application (APP) on the mobile phone. When the near field wireless transmission device is remote from the lock toolset, the user can directly input the old code and schedule to replace the old code with a new one. When next time the near field wireless transmission device gets close to the lock toolset, it can automatically unlock using the old code and then execute the code replace procedure, so that the user can schedule the code change operation on his/her own mobile phone anytime without any restriction.

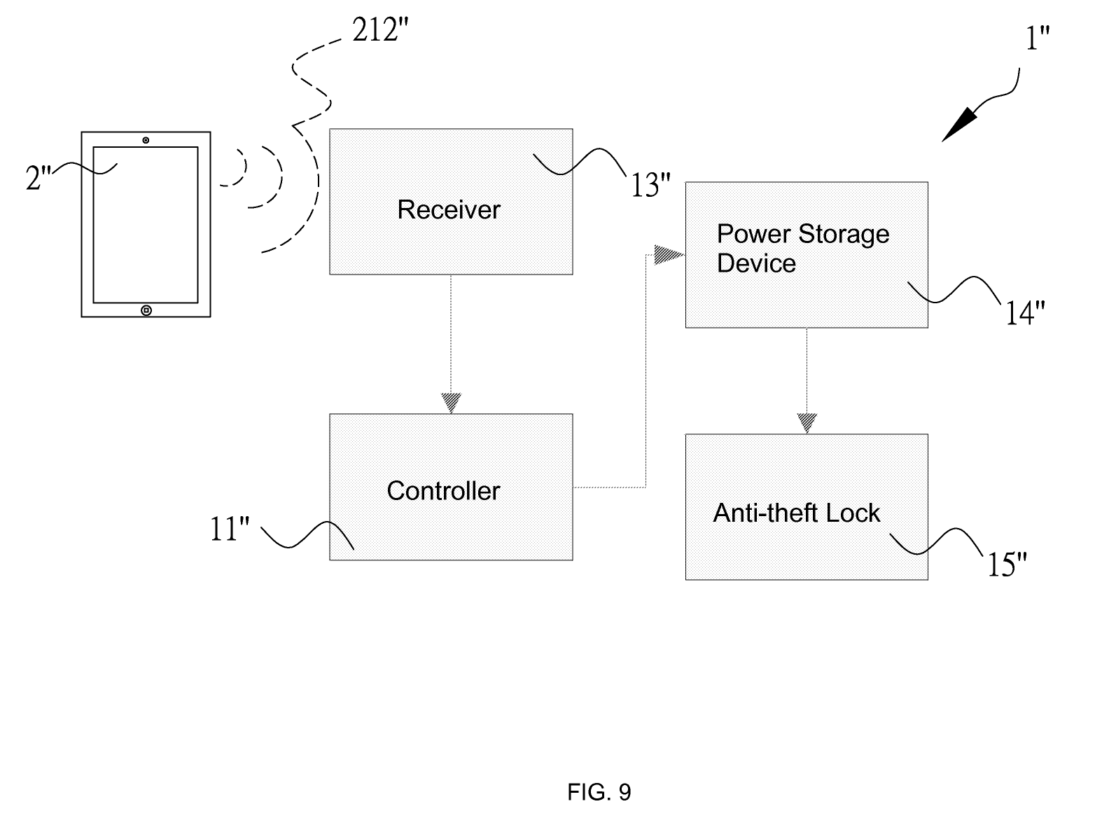

Those skilled in the art can surely understand that the lock toolset 1″ can include a power storage device 14″ according to the third preferred embodiment shown in FIG. 9. When the receiver 13″ receives a release signal 212″ transmitted from the tablet computer 2″, for example, the controller 11″ is enabled so that the controller 11″ drives the power storage device 14′ to supply energy to open the anti-theft lock 15″.

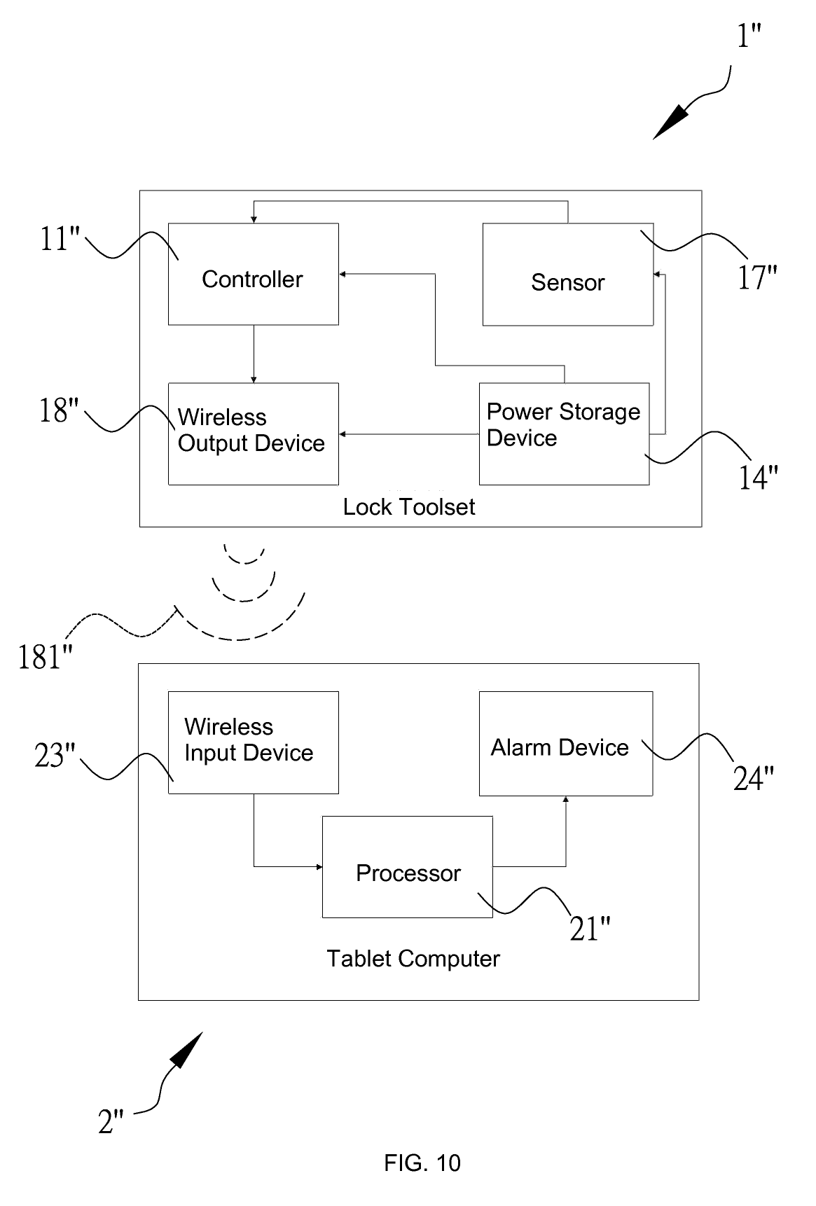

However, even with above-said various mechanisms, when the user is away from the bicycle, e.g., going to a restroom, leaving the bicycle or luggage case outdoors, the user may still worry about that thieves could possibly use a tool such as a lighter, hydraulic cutter, chain saw etc. to forcibly sabotage the lock toolset. Hence, as shown in FIG. 10, the power storage device 14″ consistently supplies electric power so that the lock toolset 1″ can retain sufficient electric power for normal operation. In this embodiment, the sensor 17″ is a vibration sensor. Once the thief takes a hydraulic cutter or even a chain saw to make an attempt to break up the lock toolset 1″, the sensor 17″ powered by the power storage device 14″ can detect drastic vibration transferred from consistent operation of the mechanic tool and send out a sense signal (not shown) to the controller 11″. Then the controller 11″ in the lock toolset 1″ drives the wireless output device 18″ to output a Bluetooth signal, for example, as an emergency signal 181″ to the mobile phone 2″ held in user's hand. The tablet computer 2″ receives the emergency signal 181″ via a corresponding wireless input device 23″, and meanwhile the processor 21″ drives the speaker of the tablet computer 2″ as an alarm device 24″ to generate alarm sound, in order to rapidly prompting the user to check out the sabotage condition of the bicycle or luggage case, thus successfully preventing theft actions.

Of course, the alarm device is by no means limited to generate speaker sound. Other approaches such as vibration or indicator light blinking or the like can be applied as well, without affecting the implementation of the embodiment. In addition, the interference condition may also be a temperature fluctuation, or a breakout of electric circuits embedded and wound in the lock toolset, or even a combination of the above-said three sensor approaches.

The present invention utilizes near field wireless transmission in conjunction with the near field wireless transmission device to provide near field wireless transmissions for RFID, NFC. Since the mobile phone must be connected to the base station all the time, and the electro-magnetic signals emitted based on such connection can be applied as a predetermined wireless activation signal consisting of information, i.e., mobile phone serial number and SIM card serial number and so on, the lock toolset installed on the portable device can easily and directly determine whether the anti-theft lock should be released. On the other hand, the user can input a release code on the touch panel of a mobile phone, so that the opportunity of illicitly recording the electro-magnetic wave signals by thieves can be also eliminated through the near field wireless transmission technology, thereby improving the security of the lock toolset. Besides, the user can further input a modification code on the touch panel of the mobile phone in accordance as per personal preference, thus modifying the release code programmed in the memory of the lock toolset and providing the lock toolset with high application flexibility. Moreover, portable devices like a bicycle or luggage case cannot be easily connected to a mains socket. It is preferably that the power storage device of the lock toolset receives electric power via a mobile phone or a tablet computer having communication function, so as to activate the controller of the lock toolset. Since the electric power will not run out because people habitually pay attention to the levels of residual power amounts in their mobile phones or tablet computers. Additionally, the USB connection used herein includes only two power pins, and does not include two signals pins. This can effectively prevent the thief from easily applying electric violent unlocking. In this way, the techniques of the present invention allows the user to maintain their existing application habits without having to consider whether the electric lock has sufficient operation electric power thus saving user's efforts and no need to worry about the portable device to be stolen by electric violence means. Furthermore, in case the thief does intend to forcibly destroy the lock toolset, the sensor installed inside the lock toolset can output a sensor signal to the controller, thus further emitting an emergency signal to notify the user that someone is currently sabotaging the lock toolset, so the user can rapidly respond and the theft action may fail thereby improving the protectiveness of the present invention and relieving the user's psychological burden.

It should be noticed that, however, the illustrations set forth as above simply describe the preferred embodiments of the present invention which are not to be construed as restrictions for the scope of the present invention; contrarily, all effectively equivalent changes and modifications conveniently made in accordance with the claims and specifications disclosed in the present invention are deemed to be encompassed by the scope of the present invention delineated in the following claims.

What is claimed is:

1. A lock/unlock method in conjunction with a near field wireless transmission device, which is applicable to a lock toolset utilized conjunctively with the near field wireless transmission device, wherein the near field wireless transmission device includes at least a transmitter and a processor for driving the transmitter to continuously send out a predetermined wireless activation signal, and wherein the lock toolset comprises a controller, at least one memory responsible for recording an authentication code, at least one receiver for receiving said wireless activation signal when the transmitter approaches, and an anti-theft lock driven to be opened by the controller, the lock/unlock method comprising the steps of:
a) receiving the predetermined wireless activation signal by means of the receiver and converting the predetermined wireless activation signal into an electric signal for output;
b) receiving the electric signal by means of the controller and verifying the electric signal with the authentication code recorded in the memory; and
c) instructing the anti-theft lock to unlock when the controller confirms that a predetermined condition is satisfied.

2. The lock/unlock method in conjunction with a near field wireless transmission device according to claim 1, wherein the predetermined condition in step c) is the authentication code.

3. The lock/unlock method in conjunction with a near field wireless transmission device according to claim 1, further comprising a code verification step d) between the steps b) and c), wherein the near field wireless transmission device includes a touch panel allowing multiple touches, and wherein when a release code is written on the touch panel, the processor drives the transmitter to convert the release code into a release signal for output, and wherein the step d) comprises the sub-steps of:
d1) receiving the release signal by means of the receiver and converting the release signal into an authentication signal for output; and
d2) receiving and confirming the authentication signal by means of the controller.

4. The lock/unlock method in conjunction with a near field wireless transmission device according to claim 3, wherein the predetermined condition in step c) is the release code.

5. The lock/unlock method in conjunction with a near field wireless transmission device according to claim 3, further comprising a code modification step e) after the step c), wherein the near field wireless transmission device includes a touch panel allowing multiple touches, and wherein when a modification code is written on the touch panel, the processor drives the transmitter to convert the modification code into a modification signal for output, and wherein the step e) further comprises the sub-steps of:
e1) receiving the modification signal by means of the receiver and converting the modification signal into a write-in signal for output;
e2) receiving the write-in signal by means of the controller; and
e3) instructing the memory to record the modification code by means of the controller and deleting the release code.

6. The lock/unlock method in conjunction with a near field wireless transmission device according to claim 1, wherein the lock toolset further comprises at least one power storage device for supplying electric power to the controller.

7. The lock/unlock method in conjunction with a near field wireless transmission device according to claim 6, further comprising a charging step f) between the steps a) and b).

8. The lock/unlock method in conjunction with a near field wireless transmission device according to claim 7, wherein the near field wireless transmission device comprises a USB port for transmitting electric power to the power storage device and the lock toolset comprises a USB connection line for connection to the USB port, the step f) comprising the sub-steps of:
f1) receiving the predetermined wireless activation signal by means of the receiver and converting the predetermined wireless activation signal into a charge signal for output; and
f2) receiving the charge signal by means of the power storage device to perform a charging operation.

9. The lock/unlock method in conjunction with a near field wireless transmission device according to claim 6, wherein the lock toolset further comprises at least one sensor powered by the power storage device.

10. The lock/unlock method in conjunction with a near field wireless transmission device according to claim 9, wherein the lock toolset further comprises at least one wireless output device for transmitting an emergency signal to the near field wireless transmission device when the sensor detects the lock toolset is subject to a predetermined interference condition.
